(19) United States
(12) Patent Application Publication
(10) Pub. No.: US 2014/0375581 A1
(43) Pub. Date: Dec. 25, 2014

(54) INPUT CONTROL METHOD AND INPUT CONTROL DEVICE

(71) Applicant: Panasonic Corporation, Osaka (JP)

(72) Inventors: TOSHIYA ARAI, Osaka (JP); SOTARO TSUKIZAWA, Osaka (JP); YOICHI IKEDA, Osaka (JP)

(21) Appl. No.: 14/307,498

(22) Filed: Jun. 18, 2014

(30) Foreign Application Priority Data
Jun. 25, 2013 (JP) 2013-132230

(51) Int. Cl. G06F 3/041

(52) U.S. Cl. CPC G06F 3/041
USPC 345/173

(57) ABSTRACT

An input control method includes a posture change detection step of detecting a change over time in a posture to a finger first joint with respect to a contact surface, a first angle change detection step of detecting a change over time in a first angle that is a bending state of the finger first joint, and a change direction determination step of determining change directions of the posture change and the first angle change. An input control device receives push-down input made by the finger based on a determination result made by a change direction determination unit.

### TECHNICAL FIELD

The present disclosure relates to an input control method and an input control device in touch input with a finger.

### BACKGROUND

In recent years, touch input for a display screen and a touch input-based operating system have become widely used in terminal devices. Such a terminal device is provided with a touch panel on a display device, which achieves intuitive operation on the display screen.

As a conventional touch input method, there is disclosed a technique of performing a function regarding a touch operation member by a touch state onto the touch operation member displayed on a display screen of a touch panel (for example, Japanese Patent No. 4,166,229).

### SUMMARY

In a conventional configuration, a touch panel, however, includes a pressure sensor and senses touch operation by pressing force onto the touch panel. That is, an operator needs to approach a position at which the touch panel is within reach of the operator's hand, and to touch on the touch panel with an instruction method such as a finger.

The present disclosure provides, in touch input, an input control method and an input control device for receiving touch operation input without limiting a contact surface to a surface of a touch panel.

An input control method according to the present disclosure is an input method of performing operation input with a finger, the method including a posture acquisition step of acquiring posture information to a finger first joint with respect to a contact surface, a posture change detection step of detecting a change in the posture over time using the posture information obtained in the posture acquisition step, a first angle acquisition step of acquiring a state of a first angle that is a bending state of the finger first joint when the posture change is detected, a first angle change detection step of detecting a change in the first angle over time using the state of the first angle obtained in the first angle acquisition step, a change direction determination step of determining change directions of the detected posture change and the first angle change, and an operation input step of receiving input made by the finger based on a determination result in the change direction determination step, wherein the input control method receives touch operation input without limiting the contact surface to a surface of a touch panel.

The input control method and the input control device according to the present disclosure make it possible, in touch input, to receive touch operation input without limiting a contact surface to a surface of a touch panel.

### BRIEF DESCRIPTION OF DRAWINGS

FIG. 1 is a diagram illustrating a system configuration that includes an input control device according to a first exemplary embodiment of the present disclosure;

FIG. 2 is a diagram illustrating an example of a hardware configuration of the input control device according to the first exemplary embodiment of the present disclosure;

FIGS. 3A to 3C are diagrams each illustrating a relationship between a finger state and a first angle according to the first exemplary embodiment of the present disclosure;

FIG. 4 is a block diagram illustrating an example of a configuration of the input control device according to the first exemplary embodiment of the present disclosure;

FIG. 5 is a flow chart illustrating an example of a process flow of the input control method according to the first exemplary embodiment of the present disclosure;

FIGS. 6A to 6B are diagrams each illustrating a relationship between the finger state and a finger posture according to the first exemplary embodiment of the present disclosure;

FIGS. 7A to 7B are diagrams each illustrating a relationship between the finger state and the finger posture according to the first exemplary embodiment of the present disclosure;

FIGS. 8A to 8B are diagrams each illustrating a relationship between the finger state and the finger posture according to the first exemplary embodiment of the present disclosure;

FIG. 9 is a block diagram illustrating an example of the configuration of the input control device according to a second exemplary embodiment of the present disclosure;

FIG. 10 is a flow chart illustrating an example of a process flow of the input control method according to the second exemplary embodiment of the present disclosure;

FIG. 11 is an outline view of a system that includes the input control device according to a third exemplary embodiment of the present disclosure; and

FIG. 12 is a block diagram illustrating an example of the configuration of the input control device according to the third exemplary embodiment of the present disclosure.

### DETAILED DESCRIPTION

### Findings Underlying the Present Disclosure

When touch input is performed to an information processing device, a touch panel that includes a pressure sensor is used. Touch operation is sensed with pressing force onto the touch panel. In this case, an operator needs to approach a position at which the touch panel is within reach of the operator's hand, and to touch on the touch panel with an instruction method such as a finger.

When an information processing device projects and displays a display screen via a projector, etc. and an operator performs operation input on the projected display screen, it is impossible to use a technique that uses a conventional touch panel.

In order to solve such problems, the present input control method is an input method of performing operation input with a finger, the method including a posture acquisition step of acquiring posture information of the finger up to a finger first joint with respect to a contact surface, a posture change detection step of detecting a change in the posture over time using the posture information obtained in the posture acquisition step, a first angle acquisition step of acquiring a state of a first angle that is a bending state of the finger first joint when the change in the posture is detected, a first angle change detection step of detecting a change in the first angle over time using the state of the first angle obtained in the first angle acquisition step, a change direction determination step of determining change directions of the detected posture change and the first angle change, and an operation input step of receiving input made by the finger based on a determination result in the change direction determination step, wherein the input control method makes it possible to receive touch operation input without limiting the contact surface to a surface of a touch panel. The input control method according to the present disclosure makes it possible to use a wall, a screen, or a top of a desk on which a display screen is projected as a contact surface on which an operator performs operation input. In addition, the contact surface on which the operator performs operation input can be a display of a display device that does not have a touch-panel function, or a part of a body, such as the operator's own palm.

Every exemplary embodiment described below shows one specific example of the present disclosure. Each of a numerical value, shape, component, step, step sequence, and the like described in the following exemplary embodiments is an example, and is not intended to limit the present disclosure. Among components in the following exemplary embodiments, a component that is not described in an independent claim indicating the most generic concept is described as an optional component. In all the exemplary embodiments, it is possible to combine content of each of the exemplary embodiments.

The following describes exemplary embodiments of the present disclosure with reference to the drawings.

### First Exemplary Embodiment

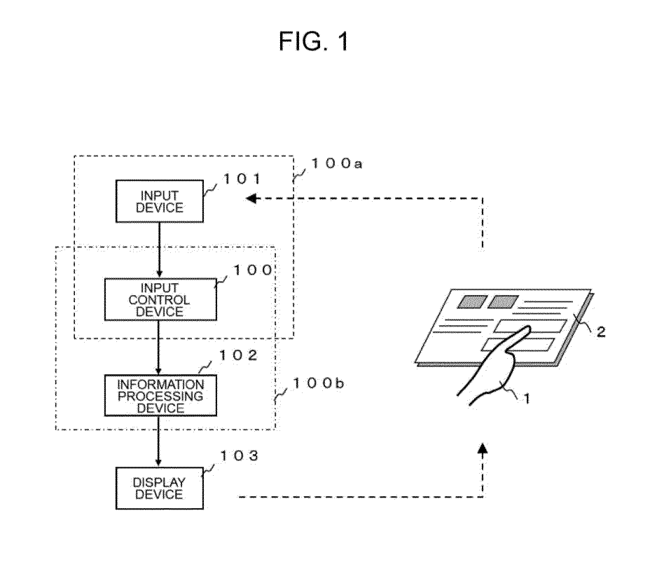

FIG. 1 is a diagram illustrating a system configuration that includes an input control device according to a first exemplary embodiment of the present disclosure.

In FIG. 1, the present system includes input device 101, input control device 100, information processing device 102, and display device 103.

An operator performs touch operation on contact surface 2 with finger 1 in order to perform operation input with a finger. Input device 101 inputs a finger state created by the operator's touch operation, and notifies input control device 100. Input control device 100 acquires posture information about the finger up to a finger first joint with respect to contact surface 2 and a state of a first angle that is a bending state of the finger first joint from the inputted finger state, and determines whether push-down operation has been made. Based on a determination result, input control device 100 determines the input made by the operator's touch operation, and notifies information processing device 102 as an input command. Information processing device 102 receives the input command and performs corresponding processing. Information processing device 102 notifies display device 103 of a display screen corresponding to the processing, and displays the screen.

In FIG. 1, display device 103 projects the outputted display screen on a plane. The operator performs touch operation onto the plane (contact surface 2) on which the display screen is projected. Contact surface 2 is a screen, a wall, a top of a desk, and the like. Contact surface 2 may be a curved surface. Contact surface 2 may be a part of a body, such as the operator's own palm.

Input device 101 is a device capable of inputting a finger state, such as a camera, a sensor, and a data glove.

Display device 103 is a display for displaying a display screen, for example, a liquid crystal display (LCD). Alternatively, display device 103 is a projector for projecting a display screen on an external screen, a wall, and the like.

Information processing device 102 is an operation object apparatus, such as an information terminal including a personal computer (PC), a communication apparatus, an electrical household appliance, and an audiovisual (AV) apparatus.

Input control device 100 may include one device that also has another function. For example, input control device 100a has a function of input device 101 that inputs a finger state created by the operator's touch operation. Input control device 100b has a function of information processing device 102 that receives input made by the operator's touch operation and performs corresponding processing. This is a configuration in which input control device 100 is incorporated into the operation object apparatus (information processing device 102).

As described above, input control device 100 makes it possible to receive touch operation input without limiting a contact surface to a surface of a touch panel.

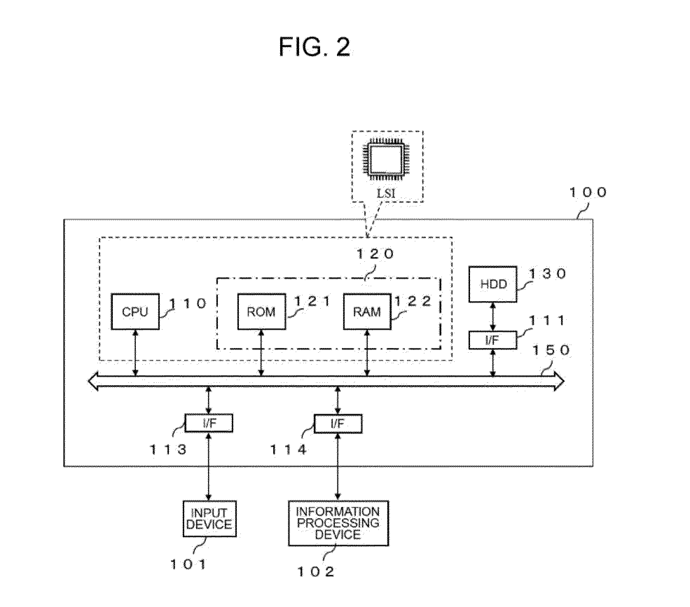

FIG. 2 is a diagram illustrating a hardware configuration of the input control device according to the exemplary embodiment of the present disclosure.

Input control device 100 includes central processing unit (CPU) 110, memory device 120, and hard disk drive 130. These devices are connected to each other via bus line 150. Hard disk drive 130 is connected to bus line 150 via interface 111. Input control device 100 is connected to input device 101 via interface 113. Input control device 100 is also connected to information processing device 102 via interface 114.

CPU 110 may include a single CPU and may include a plurality of CPUs. FIG. 2 illustrates an example in which a single CPU 110 is included.

Memory device 120 includes read only memory (ROM) 121 and random access memory (RAM) 122. ROM 121 stores a computer program and data that specify operation of CPU 110. The computer program and data may also be stored in hard disk drive 130. CPU 110 performs processing specified by the computer program while writing in RAM 122 the computer program and data stored in ROM 121 or hard disk drive 130 as necessary. RAM 122 functions also as a medium for temporarily storing data generated in connection with CPU 110 performing the processing. Memory device 120 includes a writable, nonvolatile memory that retains stored contents even if power is turned off, such as a flash memory, and a storage medium.

Hard disk drive 130 is a device for recording and retaining the computer program. Hard disk drive 130 may also record history data regarding the finger state. The history data may be recorded in RAM 122 (nonvolatile memory).

As described above, input control device 100 is configured as a computer. It is possible to supply the above-described computer program via ROM 121, hard disk drive 130, an unillustrated flexible disk, or a portable recording medium. It is also possible to supply the above-described computer program via a transmission medium such as a network. In addition, it is possible to store the read computer program in RAM 122 or hard disk drive 130.

When the computer program is supplied from ROM 121 as a program recording medium, mounting ROM 121 in input control device 100 allows CPU 110 to perform processing in accordance with the above-described computer program. The computer program supplied via the transmission medium, such as a network, is stored in, for example, RAM 122 or hard disk drive 130. The transmission medium is not limited to a wired transmission medium, but may be a wireless transmission medium.

In the configuration of FIG. 2, input control device 100 does not include input device 101 and information processing device 102. Input control device 100 is connected to input device 101 and information processing device 102 via interfaces 113 and 114, respectively. Input control device 100 may include input device 101 or information processing device 102 (100a, 100b of FIG. 1). In this configuration, for example, a computer program for performing processing of input control device 100 and a computer program for performing processing of information processing device 102 operate in one CPU 110.

Input control device 100 may be configured as an LSI. The LSI includes CPU 110 and memory device 120.

The following describes processing in which, when an operator performs touch operation onto an operation surface with a finger, an input control device determines input from a finger state created by the touch operation and notifies information processing device 102 as an input command.

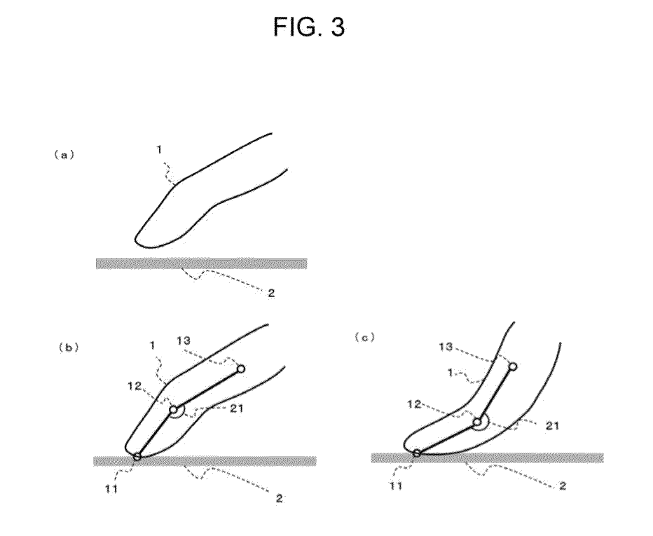

FIGS. 3A to 3C are diagrams each illustrating a finger state created by an operator's touch operation. In order of the operator's touch operation, the finger state changes as illustrated in FIG. 3A, FIG. 3B, and FIG. 3C. FIG. 3A illustrates a state before finger 1 contacts contact surface 2. FIG. 3B illustrates a weak contact state in which finger 1 contacts contact surface 2. FIG. 3C illustrates a strong contact state in which finger 1 pushes down contact surface 2.

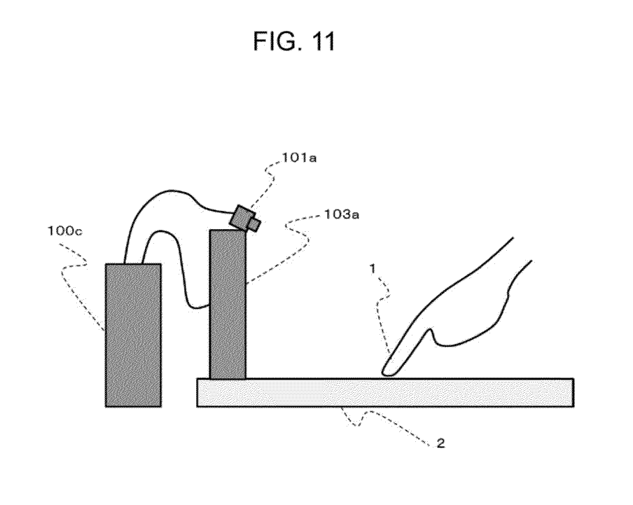

In FIGS. 3B to 3C, 11 is a fingertip that is a contact point between finger 1 and contact surface 2, 12 is a first joint of finger 1, 13 is a second joint of finger 1, and 21 is a first angle of finger 1. First angle 21 shows a bending state of the first joint of finger 1.

First angle 21, which is illustrated as an angle at finger first joint 12 in FIGS. 3B to 3C, may be defined at a point shifted from first joint 12. For example, first angle 21 may be defined at a point located between fingertip 11 and finger first joint 12, the point being separated from fingertip 11 by a predetermined distance.

In addition, the input control device according to the present disclosure performs processing using finger posture information. The finger posture information refers to information indicating a posture from fingertip 11 to finger first joint 12. For example, the posture information is an inclination of a line segment that connects fingertip 11 and finger first joint 12. The posture information is an inner product between the line segment that connects fingertip 11 and finger first joint 12, and the contact surface. The posture information is a distance from the line segment that connects fingertip 11 and finger first joint 12 to the contact surface. The posture information is a contact area of the line segment that connects fingertip 11 and finger first joint 12 with the contact surface.

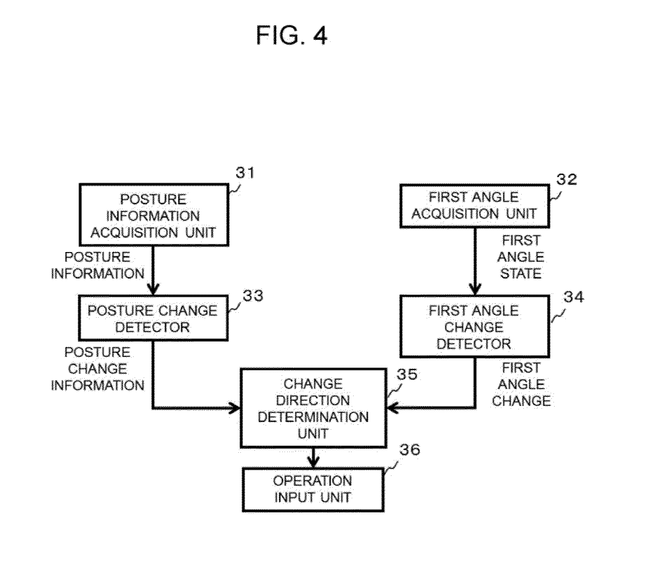

FIG. 4 is a block diagram illustrating a configuration of the input control device according to the exemplary embodiment of the present disclosure. The input control device is a program that runs in CPU 110 using memory device 120 illustrated in FIG. 2.

In FIG. 4, the input control device includes posture information acquisition unit 31, first angle acquisition unit 32, posture change detector 33, first angle change detector 34, change direction determination unit 35, and operation input unit 36. The input control device determines input from a finger state created by touch operation, determines input (push-down) or input release, and outputs input (ON) or input release (OFF) as an input command.

Posture information acquisition unit 31 acquires finger posture information using the finger state inputted by an input device, and outputs the acquired posture information to posture change detector 33. A specific method of acquiring the posture information is, for example, to perform image processing of a camera image photographed by a camera that is an input device, to detect a finger shape, and to acquire the posture information using a detection result. Another specific method of acquiring the posture information is, for example, to input data measured with various data gloves that are input devices, and to acquire the posture information using the inputted data.

First angle acquisition unit 32 acquires a finger first angle using the finger state inputted by the input device, and outputs the acquired first angle to first angle change detector 34 as a first angle state. A specific method of acquiring the first angle is, for example, to perform image processing of the camera image photographed by the camera that is an input device, to detect the finger shape, and to acquire the first angle using a detection result. Another specific method of acquiring the first angle is, for example, to input data measured with various data gloves that are input devices, and to acquire the first angle using the inputted data.

Posture change detector 33 detects a change in the posture information inputted from posture information acquisition unit 31, and outputs the detected change as posture change information. First, posture change detector 33 stores first-time posture information inputted from posture information acquisition unit 31. Next, posture change detector 33 compares posture information newly inputted from posture information acquisition unit 31 with the first-time posture information. Posture change detector 33 detects whether the posture from fingertip 11 to finger first joint 12 becomes more parallel with the contact surface, and outputs a detection result to change direction determination unit 35 as the posture change information. After operation input unit 36 receives input, posture change detector 33 compares the posture information newly inputted from posture information acquisition unit 31 with last posture information at a time of the input reception. Posture change detector 33 detects whether the posture from fingertip 11 to finger first joint 12 becomes more perpendicular to the contact surface, and outputs a detection result to change direction determination unit 35 as the posture change information.

First angle change detector 34 detects a change in the first angle from the first angle state inputted from first angle acquisition unit 32, and outputs the detected change as a first angle change. First, first angle change detector 34 acquires and stores a first-time first angle from a first-time first angle state inputted from first angle acquisition unit 32. Next, first angle change detector 34 acquires the first angle from the first angle state that is newly inputted from first angle acquisition unit 32, and compares the acquired first angle with the first-time first angle. First angle change detector 34 calculates a difference between the first-time first angle and the newly inputted first angle, detects the first angle change, and outputs the first angle change to change direction determination unit 35. After operation input unit 36 receives input, first angle change detector 34 compares the first angle from the first angle state newly inputted from first angle acquisition unit 32 with a last first angle at a time of the input reception. First angle change detector 34 calculates a difference between the last first angle at a time of the input reception and the newly inputted first angle, detects the first angle change, and outputs the detected first angle change to change direction determination unit 35.

Change direction determination unit 35 determines whether push-down operation has been made based on the posture change and whether the first angle change is positive or negative. Change direction determination unit 35 determines that change directions of the posture change and the first angle change each are a push-down direction when the posture from fingertip 11 to finger first joint 12 becomes more parallel with the contact surface and the first angle becomes larger. A state in which the directions of the posture change and the first angle change each are a push-down direction refers to, as illustrated in FIG. 3C, a state of pushing the finger more compared with FIG. 3B. After operation input unit 36 receives input, change direction determination unit 35 determines whether the push-down release operation has been made based on the posture change and whether the first angle change is positive or negative. Change direction determination unit 35 determines that the directions of the posture change and the first angle change each are a push-down release direction when the posture from fingertip 11 to finger first joint 12 becomes more perpendicular to the contact surface and the first angle becomes smaller. A state in which the directions of the posture change and the first angle change each are a push-down release direction refers to a state of transition from a state of FIG. 3C to a state of FIG. 3B, and restoring the finger. That is, in this state, push-down operation is deemed to be released.

Operation input unit 36 outputs input (ON) as an input command when change direction determination unit 35 determines that the change direction is the push-down direction. On the other hand, operation input unit 36 outputs input release (OFF) as an input command when change direction determination unit 35 determines that the change direction is the push-down release direction.

As described above, the input control device according to the present disclosure makes it possible to receive touch operation input without limiting a contact surface to a surface of a touch panel. The input control device according to the present disclosure makes it possible to use a wall, a screen, or a top of a desk on which a display screen is projected as a contact surface on which an operator performs operation input. In addition, the contact surface on which the operator performs operation input can be a display of a display device that does not have a touch-panel function, or a part of a body, such as the operator's own palm.

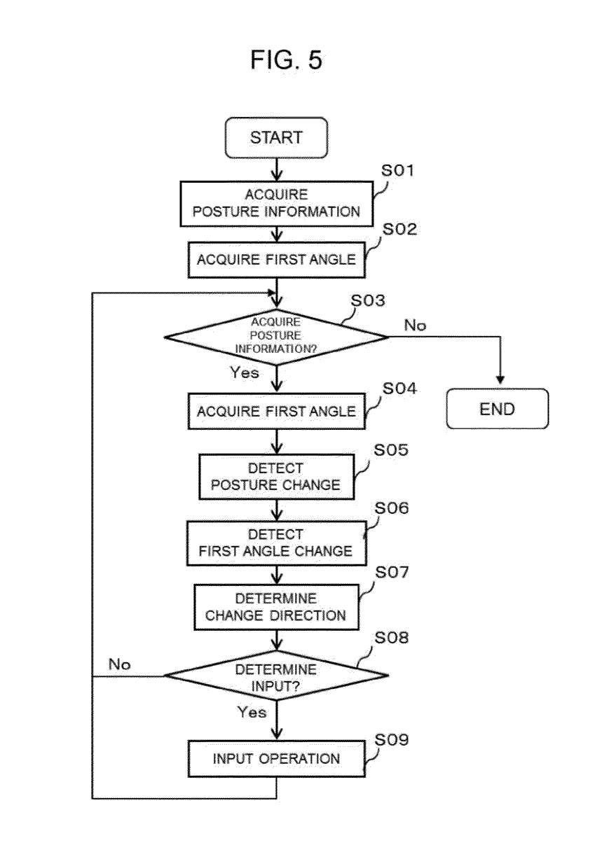

FIG. 5 is a flow chart of an input control method according to the present disclosure. The following describes each function step and a processing flow of an input method according to the present disclosure with reference to FIGS. 3A to 3C, FIG. 4, and FIG. 5.

The processing starts when a finger makes a transition from a state illustrated in FIG. 3A to a state illustrated in FIG. 3B. The following describes a processing procedure of determining a transition from the weak contact state of FIG. 3B to the strong contact state of FIG. 3C, and receiving input.

In posture acquisition step S01, posture information acquisition unit 31 acquires posture information with a finger state inputted by an input device, and outputs the acquired posture information to posture change detector 33. Posture change detector 33 stores the posture information inputted from posture information acquisition unit 31 with first-time posture information as reference posture information.

In first angle acquisition step S02, first angle acquisition unit 32 acquires a finger first angle using the finger state inputted by the input device, and outputs the acquired first angle to first angle change detector 34 as a first angle state. First angle change detector 34 acquires a first-time first angle from a first-time first angle state inputted from first angle acquisition unit 32, and stores the first angle as a reference first angle.

Next, in posture information acquisition step S03, posture information acquisition unit 31 acquires posture information again (Yes in step S03), and outputs the acquired posture information to posture change detector 33. When posture information cannot be acquired (No in step S03), that is, when the finger is away from the contact surface, posture information acquisition unit 31 ends the processing.

In first angle acquisition step S04, first angle acquisition unit 32 acquires a first angle again, and outputs the acquired first angle to first angle change detector 34.

In posture change detection step S05, posture change detector 33 compares the reference posture information with the newly inputted posture information. Posture change detector 33 detects whether the posture from fingertip 11 to finger first joint 12 becomes more parallel with the contact surface, and outputs a detection result to change direction determination unit 35 as posture change information. At this time, the reference posture information is the first-time posture information.

In first angle change detection step S06, first angle change detector 34 compares the reference first angle with the newly inputted first angle. First angle change detector 34 calculates a difference between the reference first angle and the newly inputted first angle by the following equation, detects a first angle change, and outputs the detected first angle change to change direction determination unit 35. At this time, the reference first angle is the first-time first angle.

First angle change=reference first angle−newly inputted first angle

In change direction determination step S07, change direction determination unit 35 determines whether push-down operation has been made based on the posture change and whether the first angle change is positive or negative. Change direction determination unit 35 determines that directions of the posture change and the first angle change each are a push-down direction when the posture from fingertip 11 to finger first joint 12 becomes more parallel with the contact surface and the first angle becomes larger. A state in which the directions of the posture change and the first angle change each are a push-down direction refers to, as illustrated in FIG. 3C, a state of pushing the finger more compared with FIG. 3B.

Change direction determination unit 35 determines input when a determination result in change direction determination step S07 shows that the directions of the posture change and the first angle change each are a push-down direction (Yes in step S08). In operation input step S08, operation input unit 36 receives the determined input, and outputs input (ON) as an input command.

On the other hand, change direction determination unit 35 makes a transition to step S03 when the determination result in change direction determination step S07 shows that the change directions are not the push-down direction (No in step S08). The input control device repeats an input-waiting state for acquiring posture information and a first angle again.

Next, the following describes a processing procedure of determining a transition from the strong contact state of FIG. 3C to the weak contact state of FIG. 3B, and receiving input release. The processing of receiving input release is processing after a transition is made from step S01 to step S09 in FIG. 5 and operation input unit 36 receives input. The following describes processing after a transition from step S09 to step S03. In addition, when operation input unit 36 receives input in step S09, posture change detector 33 changes the reference posture information to posture information lastly acquired at a time of input reception. When operation input unit 36 receives input, first angle change detector 34 changes the reference first angle to a first angle lastly acquired at a time of input reception.

In posture information acquisition step S03, posture information acquisition unit 31 acquires posture information again (Yes in step S03), and outputs the acquired posture information to posture change detector 33. When posture information cannot be acquired (No in step S03), that is, when the finger is away from the contact surface, posture information acquisition unit 31 ends the processing.

In first angle acquisition step S04, first angle acquisition unit 32 acquires a first angle again, and outputs the acquired first angle to first angle change detector 34.

In posture change detection step S05, posture change detector 33 compares the reference posture information with the newly inputted posture information. Posture change detector 33 detects whether the posture from fingertip 11 to finger first joint 12 becomes more perpendicular to the contact surface, and outputs a detection result to change direction determination unit 35 as posture change information. At this time, the reference posture information is posture information lastly acquired at a time of input reception.

In first angle change detection step S06, first angle change detector 34 compares the reference first angle with the newly inputted first angle. First angle change detector 34 calculates a difference between the reference first angle and the newly inputted first angle based on the above-described equation, detects the first angle change, and outputs the detected first angle change to change direction determination unit 35. At this time, the reference first angle is a first angle lastly acquired at a time of input reception.

In change direction determination step S07, change direction determination unit 35 determines whether push-down release operation has been made based on the posture change and whether the first angle change is positive or negative. Change direction determination unit 35 determines that directions of the posture change and the first angle change each are a push-down release direction when the posture from fingertip 11 to finger first joint 12 becomes more perpendicular to the contact surface and the first angle becomes smaller. The finger is in a state in which a transition is made from the state of FIG. 3C to the state of FIG. 3B, the finger is restored, and push-down operation is released.

Change direction determination unit 35 determines input when a determination result in change direction determination step S07 shows that the directions of the posture change and the first angle change each are a push-down release direction (Yes in step S08). In operation input step S08, operation input unit 36 receives the determined input release, and outputs input (OFF) as an input command.

On the other hand, change direction determination unit 35 makes a transition to step S03 when the determination result in change direction determination step S07 shows that the change directions are not the push-down release directions (No in step S08). The input control device repeats an input-waiting state for acquiring posture information and a first angle again.

When posture information cannot be acquired (No in step S03), that is, when the finger is away from the contact surface, operation input unit 36 may output input (OFF) as an input command assuming that input is released.

In addition, when operation input unit 36 receives input release in step S09, posture change detector 33 changes the reference posture information to posture information lastly acquired at a time of input release reception. When operation input unit 36 receives input release, first angle change detector 34 changes the reference first angle to a first angle lastly acquired at a time of input release reception. This makes it possible to make a transition from step S09 to S03 of FIG. 5 and to repeat processing of receiving input until the finger is away from the contact surface.

As described above, the input control method according to the present disclosure makes it possible to receive touch operation input without limiting a contact surface to a surface of a touch panel. The input control device according to the present disclosure makes it possible to use a wall, a screen, or a top of a desk on which a display screen is projected as a contact surface on which an operator performs operation input. In addition, the contact surface on which the operator performs operation input can be a display of a display device that does not have a touch-panel function, or a part of a body, such as the operator's own palm.

When there is no input of posture information, the input control device according to the present disclosure can also estimate push-down by using only input of first angle information. In this case, it is necessary to distinguish whether the operator has performed touch operation on an operation surface with a finger, or whether the operator has arbitrarily moved a finger in operation other than touch operation. The input control device can distinguish by specifying beforehand a movable range in which a finger can be arbitrarily moved.

Next, finger posture information will be described in detail.

The finger posture information refers to information indicating a posture from fingertip 11 to finger first joint 12. For example, the posture information is an inclination of a line segment that connects fingertip 11 and finger first joint 12. The posture information is an inner product between the line segment that connects fingertip 11 and finger first joint 12, and the contact surface. The posture information is a distance from the line segment that connects fingertip 11 and finger first joint 12 to the contact surface. The posture information is a contact area of the line segment that connects fingertip 11 and finger first joint 12 with the contact surface.

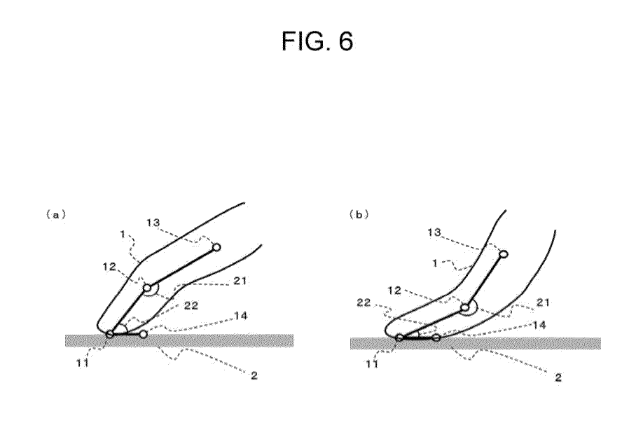

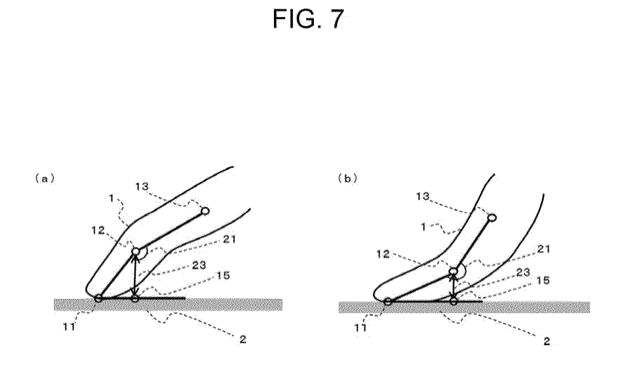

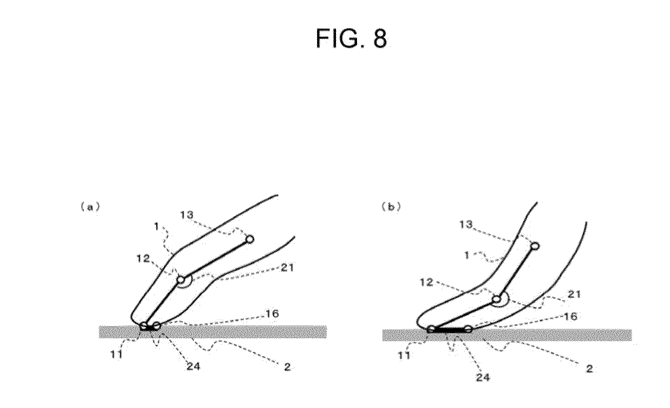

FIGS. 6A to 6B each illustrate a case where the finger posture information is an inclination of the line segment that connects fingertip 11 and finger first joint 12. FIGS. 7A to 7B each illustrate a case where the finger posture information is a distance from the line segment that connects fingertip 11 and finger first joint 12 to the contact surface. FIGS. 8A to 8B each illustrate a case where the finger posture information is a contact area of the line segment that connects fingertip 11 and finger first joint 12 with the contact surface.

The following describes a case where an angle (second angle) between the finger and the contact surface is used as the finger posture information.

FIGS. 6A to 6B are diagrams each illustrating a relationship between the finger and the angle (second angle) formed by the finger and the contact surface, the angle being used as finger posture information. FIG. 6A coincides with the state of FIG. 3B, and FIG. 6B coincides with the state of FIG. 3C. Reference numeral 14 is an auxiliary point for defining bending of the finger and the contact surface at contact point 11, and 22 is the second angle. The input control device according to the present disclosure determines a transition from a weak contact state of FIG. 6A to a strong contact state of FIG. GB, and receives input.

In posture change detection step S05 of FIG. 5, posture change detector 33 compares a reference second angle with a second angle newly inputted in posture information acquisition step S03. Posture change detector 33 calculates a difference between the reference second angle and the newly inputted second angle based on the following equation, detects the second angle change, and outputs the detected second angle change to change direction determination unit 35. At this time, the reference second angle is a first-time second angle.

Second angle change=reference second angle−newly inputted second angle

In change direction determination step S07, change direction determination unit 35 determines whether push-down operation has been made based on whether the first angle change and the second angle change are positive or negative. Change direction determination unit 35 determines that directions of the posture change and the first angle change each are a push-down direction when the first angle becomes larger and the second angle becomes smaller.

On the other hand, change direction determination unit 35 makes a transition to step S03 when a determination result in change direction determination step S07 shows that the change directions are not push-down directions (No in step S08). The input control device repeats an input-waiting state for acquiring a first angle and a second angle again.

Next, the following describes a processing procedure of determining a transition from the strong contact state of FIG. 6B to the weak contact state of FIG. GA, and receiving input release. The processing of receiving input release is processing after a transition is made from step S01 to step S09 in FIG. 5 and operation input unit 36 receives input. When operation input unit 36 receives input in step S09, posture change detector 33 changes the reference second angle to a second angle lastly acquired at a time of input reception.

In change direction determination step S07, change direction determination unit 35 determines whether push-down release operation has been made based on whether the first angle change and the second angle change are positive or negative. Change direction determination unit 35 determines that directions of the posture change and the first angle change each are a push-down release direction when the first angle becomes smaller and the second angle becomes larger.

The second angle can be acquired only in a state where the fingertip is in contact with the contact surface. The input control device can simultaneously achieve determination of whether the finger is in a noncontact state as illustrated in FIG. 3A by using the second angle at a contact point as posture information.

When the second angle is used as posture information, change direction determination unit 35 may perform determination different from determination described above. In change direction determination step S07, change direction determination unit 35 determines that directions of the posture change and the first angle change each are a push-down direction when the first angle becomes larger and a change of the first angle is larger than a predetermined value, and when the second angle becomes smaller and a change of the second angle is larger than a predetermined value, based on whether the first angle change and the second angle change are positive or negative, and based on absolute values of the first angle change and the second angle change.

In this case, it is possible to avoid operation that the operator does not intend by ignoring the operation when the first angle change and the second angle change are small, for example, when the operator's fingertip unintentionally moves. On the other hand, when touch operation is intentional, as illustrated in FIG. 3C, it is possible to perform the touch operation simply and securely by pushing the finger lightly until the fingertip bends.

In addition, it is also possible to change subsequent processing depending on magnitude of push-down by providing a plurality of change thresholds.

As described above, the input control method and the input control device according to the present disclosure make it possible to receive touch operation input without limiting a contact surface to a surface of a touch panel. The input control device according to the present disclosure makes it possible to use a wall, a screen, or a top of a desk on which a display screen is projected as a contact surface on which an operator performs operation input. In addition, the contact surface on which the operator performs operation input can be a display of a display device that does not have a touch-panel function, or a part of a body, such as the operator's own palm.

### Second Exemplary Embodiment

An input control device according to an exemplary embodiment of the present disclosure has a function of acquiring elapsed time from first time when determination is made that directions of a posture change and a first angle change each are a push-down direction. The input control device also has a function of changing a type of input to receive based on the elapsed time.

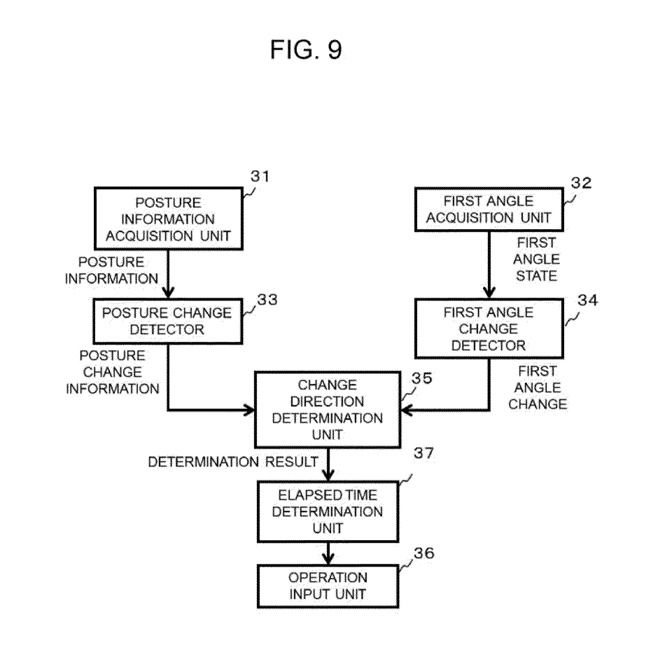

FIG. 9 is a block diagram illustrating a configuration of the input control device according to the exemplary embodiment of the present disclosure. The input control device is a program executed by CPU 110 using memory device 120 illustrated in FIG. 2.

In FIG. 9, the input control device includes posture information acquisition unit 31, first angle acquisition unit 32, posture change detector 33, first angle change detector 34, change direction determination unit 35, elapsed time determination unit 37, and operation input unit 38. The input control device determines input from a finger state created by touch operation, determines input (short push, long push), and outputs the input (short push) or the input (long push) as an input command.

Posture information acquisition unit 31, first angle acquisition unit 32, posture change detector 33, first angle change detector 34, and change direction determination unit 35 are identical to those in FIG. 4 described above, and hence description will be omitted.

When change direction determination unit 35 determines that the change direction is a push-down direction, elapsed time determination unit 37 records the first time of push-down operation. Next, when change direction determination unit 35 determines that the change direction is a push-down release direction, elapsed time determination unit 37 outputs elapsed time from the first time to second time when push-down is released to operation input unit 38.

Operation input unit 38 determines the type of input to receive based on the elapsed time outputted by elapsed time determination unit 37, and outputs an input command. Operation input unit 38 determines input (short push) when the elapsed time is equal to or shorter than predetermined time. Operation input unit 38 determines input (long push) when the elapsed time is longer than the predetermined time. In addition, operation input unit 38 may retain a plurality of reference time such as predetermined time 1 and predetermined time 2 (time 1<time 2). Operation input unit 38 determines input (short push) when the elapsed time is equal to or shorter than time 1. Operation input unit 38 determines input (long push) when the elapsed time is longer than time 1 and equal to or shorter than time 2. Operation input unit 38 determines input (long push 2) when the elapsed time is longer than time 2. In addition, operation input unit 38 may assign another function in advance. For example, operation input unit 38 determines input (right click) when the elapsed time is equal to or shorter than time 1. Operation input unit 38 determines input (right long push) when the elapsed time is longer than time 1 and equal to or shorter than time 2. Operation input unit 38 determines input (left click) when the elapsed time is longer than time 2.

As described above, the input control device according to the present disclosure makes it possible to receive touch operation input without limiting a contact surface to a surface of a touch panel. The input control device according to the present disclosure makes it possible to use a wall, a screen, or a top of a desk on which a display screen is projected as a contact surface on which an operator performs operation input. In addition, the contact surface on which the operator performs operation input can be a display of a display device that does not have a touch-panel function, or a part of a body, such as the operator's own palm.

In addition, the input control device according to the present disclosure makes it possible to change a type of input to receive based on the elapsed time. The input control device according to the present disclosure facilitates control by switching an input command to output depending on an operation object apparatus.

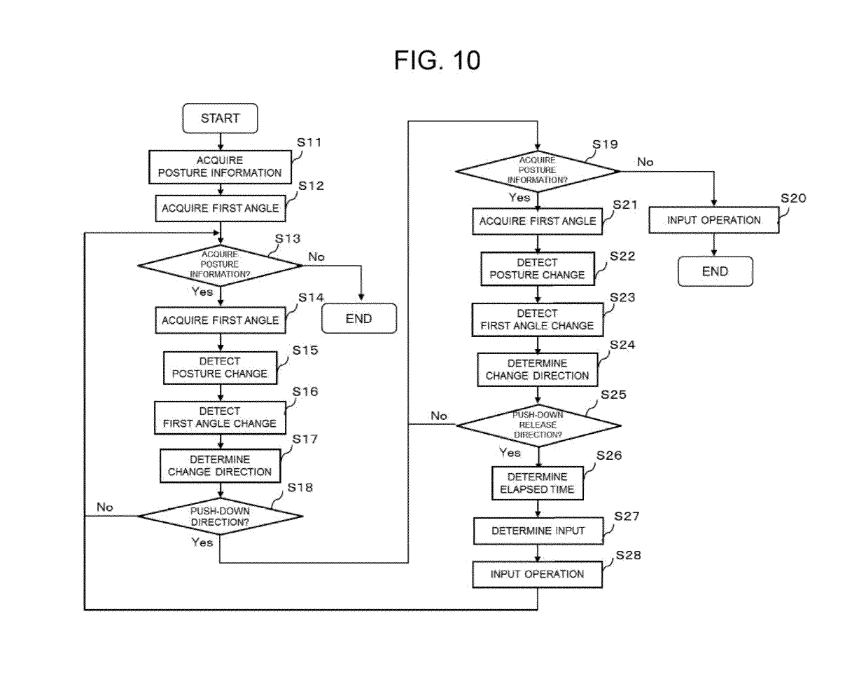

FIG. 10 is a flow chart of the input control method according to the present disclosure. The following describes each function step and a processing flow of an input method according to the present disclosure with reference to FIG. 9 and FIG. 10. Herein, operation input unit 38 determines input (short push) when the elapsed time is equal to or shorter than predetermined time. Operation input unit 38 determines input (long push) when the elapsed time is longer than the predetermined time.

In posture acquisition step S11, posture information acquisition unit 31 acquires posture information with a finger state inputted by an input device, and outputs the acquired posture information to posture change detector 33. Posture change detector 33 stores first-time posture information inputted from posture information acquisition unit 31 as reference posture information.

In first angle acquisition step S12, first angle acquisition unit 32 acquires a finger first angle using the finger state inputted by the input device, and outputs the acquired first angle to first angle change detector 34 as a first angle state. First angle change detector 34 acquires a first-time first angle from a first-time first angle state inputted from first angle acquisition unit 32, and stores the acquired first-time first angle as a reference first angle.

Next, in posture information acquisition step S13, posture information acquisition unit 31 acquires posture information again (Yes in step S13) and outputs the acquired posture information to posture change detector 33. When posture information cannot be acquired (No in step S13), that is, when the finger is away from the contact surface, posture information acquisition unit 31 ends the processing.

In first angle acquisition step S14, first angle acquisition unit 32 acquires a first angle again and outputs the acquired first angle to first angle change detector 34.

In posture change detection step S15, posture change detector 33 compares the reference posture information with the newly inputted posture information. Posture change detector 33 detects whether the posture from fingertip 11 to finger first joint 12 becomes more parallel with the contact surface, and outputs a detection result to change direction determination unit 35 as posture change information. At this time, the reference posture information is first-time posture information.

In first angle change detection step S16, first angle change detector 34 compares the reference first angle with the newly inputted first angle. First angle change detector 34 calculates a difference between the reference first angle and the newly inputted first angle based on the following equation, detects a first angle change, and outputs the detected first angle change to change direction determination unit 35. At this time, the reference first angle is a first-time first angle.

First angle change=reference first angle−newly inputted first angle

In change direction determination step S17, change direction determination unit 35 determines whether push-down operation has been made based on the posture change and whether the first angle change is positive or negative. Change direction determination unit 35 determines that directions of the posture change and the first angle change each are a push-down direction when the posture from fingertip 11 to finger first joint 12 becomes more parallel with the contact surface and the first angle becomes larger.

Change direction determination unit 35 makes a transition to step S19 when a determination result in change direction determination step S17 shows that the change directions of the posture change and the first angle change each are a push-down direction (Yes in step S18). At this time, elapsed time determination unit 37 records the first time of push-down operation. Posture change detector 33 changes the reference posture information to posture information lastly acquired at a time of input reception. First angle change detector 34 changes the reference first angle to a first angle lastly acquired at a time of input reception.

On the other hand, change direction determination unit 35 makes a transition to step S13 when the determination result in change direction determination step S17 shows that the change directions are not each push-down direction (No in step S18). The input control device repeats an input-waiting state for acquiring posture information and a first angle again.

In posture information acquisition step S19, posture information acquisition unit 31 acquires posture information again (Yes in step S19) and outputs the acquired posture information to posture change detector 33. On the other hand, when posture information acquisition unit 31 fails to acquire posture information (No in step S19), that is, when the finger is away from the contact surface, operation input unit 38 performs the processing as the elapsed time being equal to or shorter than predetermined time in operation input step S20. Since the elapsed time is equal to or shorter than the predetermined time, operation input unit 38 determines that a type of input to receive is input (short push), outputs an input command, and ends the processing.

In first angle acquisition step S21, first angle acquisition unit 32 acquires a first angle again and outputs the acquired first angle to first angle change detector 34.

In posture change detection step S22, posture change detector 33 compares the reference posture information with the newly inputted posture information. Posture change detector 33 detects whether the posture from fingertip 11 to finger first joint 12 becomes more perpendicular to the contact surface, and outputs a detection result to change direction determination unit 35 as posture change information. At this time, the reference posture information is posture information lastly acquired at a time of input reception.

In first angle change detection step S23, first angle change detector 34 compares the reference first angle with the newly inputted first angle. First angle change detector 34 calculates a difference between the reference first angle and the newly inputted first angle based on the above-described equation, detects the first angle change, and outputs the detected first angle change to change direction determination unit 35. At this time, the reference first angle is a first angle lastly acquired at a time of input reception.

In change direction determination step S24, change direction determination unit 35 determines whether push-down release operation has been made based on the posture change and whether the first angle change is positive or negative. Change direction determination unit 35 determines that directions of the posture change and the first angle change each are a push-down release direction when the posture from fingertip 11 to finger first joint 12 becomes more perpendicular to the contact surface and the first angle becomes smaller.

Change direction determination unit 35 makes a transition to step S26 when a determination result in change direction determination step S24 shows that the change directions of the posture change and the first angle change each are a push-down release direction (Yes in step S25).

In elapsed time determination step S26, elapsed time determination unit 37 outputs elapsed time from the first time to second time when push-down is released to operation input unit 38.

In input determination step S27, operation input unit 38 determines a type of input to receive based on the elapsed time. In operation input step S28, operation input unit 38 outputs an input command depending on the type of input determined in step S27.

On the other hand, change direction determination unit 35 makes a transition to step S19 when the determination result in change direction determination step S24 shows that the change directions are not each push-down release direction (No in step S25). The input control device repeats an input-release-waiting state for acquiring posture information and a first angle again.

After outputting the input command in step S28, operation input unit 38 makes a transition to step S13. At this time, posture change detector 33 changes the reference posture information to posture information lastly acquired at a time of input release reception. First angle change detector 34 changes the reference first angle to a first angle lastly acquired at a time of input release reception. This makes it possible to make a transition from step S28 to S13 and to repeat processing of receiving input until the finger is away from the contact surface.

As described above, the input control method according to the present disclosure makes it possible to receive touch operation input without limiting a contact surface to a surface of a touch panel. The input control device according to the present disclosure makes it possible to use a wall, a screen, or a top of a desk on which a display screen is projected as a contact surface on which an operator performs operation input. In addition, the contact surface on which the operator performs operation input can be a display of a display device that does not have a touch-panel function, or a part of a body, such as the operator's own palm.

In addition, the input control method according to the present disclosure makes it possible to change a type of input to receive based on elapsed time. The input control device according to the present disclosure facilitates control by switching an input command to output depending on an operation object apparatus.

### Third Exemplary Embodiment

An input control device according to an exemplary embodiment of the present disclosure is configured to use a camera to acquire a finger state created by an operator's touch operation. The input control device uses an image inputted from the camera to acquire posture information and a first angle. In the present exemplary embodiment, an example will be described in which an angle (second angle) between a finger and a contact surface is used as the posture information. As in the first exemplary embodiment and the second exemplary embodiment, the posture information refers to information indicating a posture from fingertip 11 to finger first joint 12. Information other than the second angle may be used as the posture information.

FIG. 11 is an outline view of a system that includes the input control device according to the exemplary embodiment of the present disclosure.

In FIG. 11, the present system includes camera 101a that is an input device, input control device 100c, and monitor 103a that is a display device. FIG. 11 illustrates an example in which the input control device is incorporated into an operation object apparatus (information processing device). As in the first exemplary embodiment and the second exemplary embodiment, the input control device may be configured to notify a determined input command to the information processing device.

The operator, who performs operation input with a finger, performs touch operation on contact surface 2 with finger 1. Camera 101a photographs the finger state created by the operator's touch operation, and notifies photographed image information to input control device 100c. Input control device 100c analyzes the inputted image information and acquires the posture information (second angle) to the finger first joint with respect to contact surface 2 and the first angle that is a bending state of the finger first joint. Input control device 100c determines whether push-down operation has been made using the first angle and the second angle. Based on a determination result, input control device 100c determines input made by the operator's touch operation and receives the input.

Although FIG. 11 illustrates only one camera, the system may include multi-spot cameras and may be configured such that image information is notified from each of the cameras to the input control device.

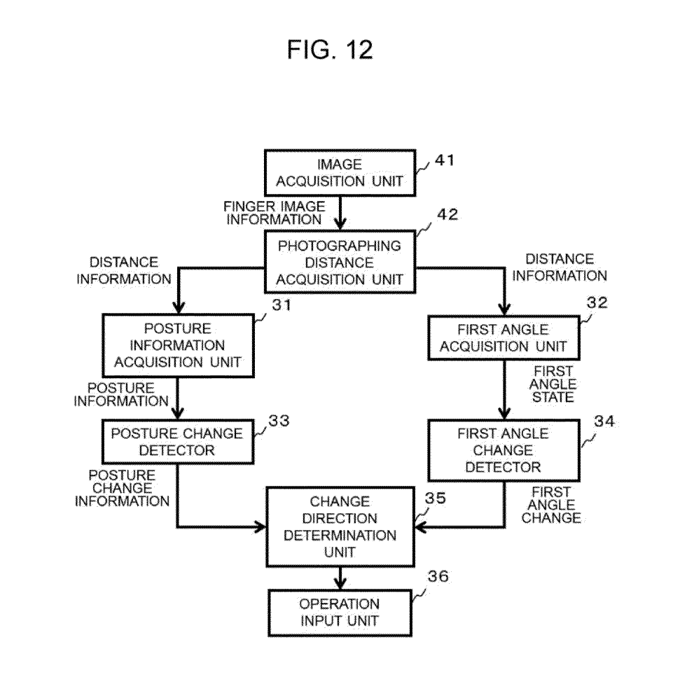

FIG. 12 is a block diagram illustrating a configuration of the input control device according to the exemplary embodiment of the present disclosure.

In FIG. 12, the input control device includes posture information acquisition unit 31, first angle acquisition unit 32, posture change detector 33, first angle change detector 34, change direction determination unit 35, operation input unit 36, image acquisition unit 41, and photographing distance acquisition unit 42. The input control device acquires image information photographed by the camera, analyzes the image information, determines input from the finger state created by touch operation, and receives the input.

Posture information acquisition unit 31, first angle acquisition unit 32, posture change detector 33, first angle change detector 34, change direction determination unit 35, and operation input unit 36 are identical to those in FIG. 4 described above, and hence description will be omitted.

Image acquisition unit 41 acquires image information photographed by camera 101a, analyzes the image information, and extracts a portion corresponding to the operator's finger. Image acquisition unit 41 outputs the extracted finger image information to photographing distance acquisition unit 42. The finger image information includes, for example, positional information that indicates a position of the extracted finger. As a method of extracting finger image information, image acquisition unit 41 uses a method such as template matching and learning algorithm.

Photographing distance acquisition unit 42 acquires distance information with respect to the photographed finger based on the image information including the positional information outputted by image acquisition unit 41. Photographing distance acquisition unit 42 outputs the acquired distance information to posture information acquisition unit 31 and first angle acquisition unit 32.

Accordingly, posture information acquisition unit 31 and first angle acquisition unit 32 acquire the distance information from photographing distance acquisition unit 42 and perform processing. Based on the distance information, posture information acquisition unit 31 acquires the second angle that is an angle formed by the finger and the contact surface. Based on the distance information, first angle acquisition unit 32 acquires the first angle that is a bending state of the finger joint.

The camera may be capable of measuring a distance and configured to output measured distance information to the input control device. In this case, the camera has functions of image acquisition unit 41 and photographing distance acquisition unit 42. The camera acquires the distance information from the photographed image information and outputs the distance information to the input control device. The input control device acquires the posture information (second angle) and the first angle using the distance information outputted from the camera.

As described above, the input control method and the input control device according to the present disclosure make it possible to receive touch operation input without limiting a contact surface to a surface of a touch panel. The input control device according to the present disclosure makes it possible to use a wall, a screen, or a top of a desk on which a display screen is projected as a contact surface on which an operator performs operation input. In addition, the contact surface on which the operator performs operation input can be a display of a display device that does not have a touch-panel function, or a part of a body, such as the operator's own palm.

The input control device according to the present disclosure acquires the first angle and the second angle based on the image information photographed by the camera. This makes it possible to use any place as a contact surface on which the operator performs operation as long as the place can be photographed with the camera.

What is claimed is:

1. An input control method of performing operation input with a finger, the method comprising:
a posture acquisition step of acquiring posture information that indicates a posture of the finger to a first joint with respect to a contact surface;
a posture change detection step of detecting a change in the posture over time using the posture information obtained in the posture acquisition step;
a first angle acquisition step of acquiring a state of a first angle that is a bending state of the first joint when the change in the posture over time is detected;
a first angle change detection step of detecting a change in the first angle over time using the state of the first angle obtained in the first angle acquisition step;
a change direction determination step of determining a change direction of the finger using the detected change in the posture over time and the change in the first angle over time; and
an operation input step of receiving input made by the finger based on a determination result in the change direction determination step.

2. The input control method according to claim 1, wherein
the posture information is a state of a second angle that is an angle formed by the finger and the contact surface,
the posture acquisition step includes acquiring the state of the second angle,
the posture change detection step includes detecting a change in the second angle over time using the state of the second angle obtained in the posture acquisition step, and
the operation input step includes receiving the input made by the finger when change directions of the change in the first angle over time and the change in the second angle over time are opposite.

3. The input control method according to claim 2, wherein
the first angle is an angle at the first joint on a palm side,
the second angle is an angle between the finger and the contact surface on the palm side,
the first angle change detection step includes detecting that the change in the first angle is positive when a value of the first angle becomes larger over time,
the second angle change detection step includes detecting that the change in the second angle is negative when a value of the second angle becomes smaller over time, and
the operation input step includes receiving the input made by the finger when the change in the first angle is positive and the change in the second angle is negative.

4. The input control method according to claim 2, further comprising an elapsed time determination step of acquiring elapsed time from a first time when change directions of the first angle change and the posture change are each determined to be a push-down direction in the change direction determination step,
wherein the operation input step includes changing a type of input to receive based on the elapsed time.

5. The input control method according to claim 2, wherein the operation input step includes receiving the input made by the finger when an absolute value of at least one of an amount of the first angle change and an amount of the posture change is larger than a predetermined amount of change.

6. The input control method according to claim 5, further comprising:
an image acquisition step of acquiring image data regarding the finger photographed by a camera; and
a photographing distance acquisition step of acquiring distance information with respect to the photographed finger based on the image data,
wherein the first angle acquisition step includes acquiring the first angle that is the bending state of the first joint based on the photographing distance information, and
the second angle acquisition step includes acquiring the second angle that is an angle formed by the finger and the contact surface based on the photographing distance information.

7. The input control method according to claim 1, wherein
the posture information is a contact area of the finger and the contact surface,
the posture acquisition step includes acquiring a state of the contact area,
the posture change detection step includes detecting a change in the contact area over time using the state of the contact area obtained in the posture acquisition step, and
the operation input step includes receiving the input made by the finger when change directions of the change in the first angle and the change in the contact area are identical.

8. The input control method according to claim 1, wherein
the posture information is a distance between the first joint and the contact surface,
the posture acquisition step includes acquiring the distance between the first joint and the contact surface,
the posture change detection step includes detecting a change in the distance over time using the distance between the first joint and the contact surface obtained in the posture acquisition step, and
the operation input step includes receiving the input made by the finger when change directions of the change in the first angle and the change in the distance between the first joint and the contact surface are opposite.

9. An input control device for performing operation input with a finger, the device comprising:
a posture acquisition unit configured to acquire posture information that indicates a posture of the finger to a first joint with respect to a contact surface;
a posture change detector configured to detect a change in the posture over time using the posture information obtained by the posture acquisition unit;
a first angle acquisition unit configured to acquire a state of a first angle that is a bending state of the first joint when the change in the posture over time is detected;
a first angle change detector configured to detect a change in the first angle over time using the state of the first angle obtained by the first angle acquisition unit;
a change direction determination unit configured to determine that a change direction of the first joint is a push-down direction using the detected change in the posture over time and the change in the first angle over time; and
an operation input unit configured to receive the input made by the finger based on a determination result made by the change direction determination unit.

10. The input control device according to claim 9, wherein
the posture information is a state of a second angle that is an angle formed by the finger and the contact surface,
the posture acquisition unit acquires the state of the second angle,
the posture change detector detects a change in the second angle over time using the state of the second angle obtained by the posture acquisition unit, and
the operation input unit receives the input made by the finger when change directions of the change in the first angle over time and the change in the second angle over time are opposite.

11. The input control device according to claim 10, wherein
the first angle is an angle at the first joint on a palm side,
the second angle is an angle between the finger and the contact surface on the palm side,
the first angle change detector detects that the change in the first angle is positive when a value of the first angle becomes larger over time,
the second angle change detector detects that the change in the second angle is negative when a value of the second angle becomes smaller over time, and
the operation input unit receives the input made by the finger when the change in the first angle is positive and the change in the second angle is negative.

12. The input control device according to claim 10, further comprising an elapsed time determination unit configured to acquire elapsed time from a first time when change directions of the first angle change and the posture change are each determined to be a push-down direction by the change direction determination unit,
wherein the operation input unit changes a type of input to receive based on the elapsed time.

13. The input control device according to claim 10, wherein the operation input unit receives the input made by the finger when an absolute value of at least one of an amount of the first angle change and an amount of the posture change is larger than a predetermined amount of change.

14. The input control device according to claim 13, further comprising:
an image acquisition unit configured to acquire image data regarding the finger photographed by a camera; and
a photographing distance acquisition unit configured to acquire distance information with respect to the photographed finger based on the image data,
wherein the first angle acquisition unit acquires the first angle that is the bending state of the first joint based on the photographing distance information, and
the second angle acquisition unit acquires the second angle that is an angle formed by the finger and the contact surface based on the photographing distance information.

15. The input control device according to claim 9, wherein
the posture information is a contact area of the finger and the contact surface,
the posture acquisition unit acquires a state of the contact area,
the posture change detector detects a change in the contact area over time using the state of the contact area, and
the operation input unit receives the input made by the finger when change directions of the change in the first angle and the change in the contact area are identical.

16. The input control device according to claim 9, wherein
the posture information is a distance between the first joint and the contact surface,
the posture acquisition unit acquires the distance between the first joint and the contact surface,
the posture change detector detects a change in the distance over time using the distance between the first joint and the contact surface obtained by the posture acquisition unit, and
the operation input unit receives the input made by the finger when change directions of the change in the first angle and the change in the distance between the first joint and the contact surface are opposite.
